(19) United States
(12) Patent Application Publication
(10) Pub. No.: US 2002/0093787 A1
(43) Pub. Date: Jul. 18, 2002

(54) Arm wear type communication device and high dielectric chip antenna

(76) Inventors: Takashi Ito, Chiba-shi (JP); Hideaki Nagatsuma, Chiba-shi (JP)

Correspondence Address: ADAMS & WILKS, 31st Floor, 50 Broadway, New York, NY, 10004, US

(21) Appl. No.: 10/015,404

(22) Filed: Dec. 12, 2001

(30) Foreign Application Priority Data
Dec. 28, 2000 (JP) 2000-400164

(51) Int. Cl. G06F 1/16

(52) U.S. Cl. 361/683

(57) ABSTRACT

To provide an arm wear type communication device for which the actual use form is taken into consideration. Arm holders each having no coating are provided as wear bodies in the both sides of a communication device body. Chip antennas each having a flat shape are respectively disposed in the arm holders. In this arm wear type communication device, when the communication device body is being worn to an arm, the chip antennas are respectively located on a radius side and a ulna side of an arm. Under this condition, the transmission and reception of the electric wave are carried out. When the communication device body is detached from an arm to be put to an ear to be used, the transmission and reception of the electric wave in which the grounding effect of the human body is avoided are carried out. Each of the chip antennas includes a grounding pattern on an antenna substrate, a dielectric material which is disposed on the upper part of the grounding pattern, a conductor foil called a patch pattern which is formed on the upper surface of the dielectric material.

### BACKGROUND OF THE INVENTION

1. Field of the Invention

The present invention relates to an arm wear type communication device, which is worn to an arm, and a high dielectric chip antenna.

2. Description of the Prior Art

An arm wear type communication device is super-small communication equipment, which is miniaturized up to the degree at which a body self-containing an apparatus required for the communication can be worn to an arm. Though the body is of a super-small type, the radio communication for transmitting and receiving the electric wave necessarily requires an antenna. With respect to the antenna, many conventional arm wear type communication devices have adopted a helical antenna or a whip antenna each of which projects from the chassis of the body similarly to the radio equipment until that time. Then, when carrying out the transmission and reception, a call is made towards an arm with the whip antenna stretched, or a call is made with an earphone attached to the body.

In addition, as for the arm wear type communication device in which an antenna is mounted in the special form, there are known the communication device in which a loop antenna is disposed by utilizing the length of a belt by which the body is worn to an arm (refer to Japanese Patent Application Laid-open No. Hei 04-176241, and Japanese Patent Application Laid-open No. Hei 07-283632), and the communication device in which the above-mentioned earphone is used as the antenna as well (refer to Japanese Patent Application Laid-open No. 2000-286939). In such a conventional arm wear type communication device, it becomes the premise that a call is made with such a communication device worn to an arm. That is, in the above-mentioned arm wear type communication device, it can be said that the meaning of the word called the arm wear strongly implies that the equipment is fixed to the arm. For this reason, if the antenna is also small with the same idea as that in the conventional radio communication device as the base, the antenna itself does not need to be particularly special.

On the contrary, recently, the arm wear means of the arm wear type communication device has been changed from the fixing type to the type in which the arm wear means is readily detachable. For example, both sides of the body of the communication device have two pieces of arm holders. Then, when the communication device is worn to an arm, an arm is held between these arm holders, while when the communication device is detached from an arm, an arm is released by opening these arm holders. In such a communication device, by utilizing the easiness to be detached, as in the conventional communication device, the use form becomes possible in which the communication device is held by one hand to be put to an ear and a mouth. The arm wear type communication device, which can be worn to an arm and can also be put to an ear and a mouth, must be disposed by taking into consideration the communication state when the communication device is being worn to an arm as well as the body is being held with respect to the antenna.

However, since the conventional helical antenna or the like is disposed in such a way as to project from the chassis of the body, it is easy to be hit against other objects when being carried with an arm and hence is easy to be damaged. In addition, in order to reduce the influence of the transmission and reception sensitivity provided by the human body, the consideration needs to be made in which the whip antenna is stretched and so forth. However, it is not realistic that the antenna is stretched in the state of waiting for the reception of the electric wave. In the loop antenna provided within the band, the length of the antenna is largely changed between when being worn closely to an arm, i.e., the human body and when being released to lie in the free space, and between when the band is being coupled into one piece through the clamp and when the band is not being coupled into one piece. It is as well known that if the length of the antenna is changed, then the change in the sensitivity becomes large especially in the high frequency band of several hundreds of MHz. In addition, it is also known that the antenna suffers the influence of the electric wave shielding effect provided by the chassis coating material.

### SUMMARY OF THE INVENTION

In the light of the foregoing, the present invention has been made in order to solve the above-mentioned problems associated with the prior art, and it is therefore an object of the present invention to provide an antenna disposition structure of an arm type communication device which is convenient in the state in which a communication device body is worn to an arm or in the state in which a communication device is detached from an arm to hold the body by one hand (and a high dielectric chip antenna).

In order to solve the above-mentioned problems, according to the present invention, there is provided an arm wear type communication device which includes a communication device body for transmitting and receiving a signal, a wear body which is pivotally fixed to the communication device body in order to be worn to an arm, a sound unit which is provided in the wear body, and an antenna which is located between the sound unit and the communication device body and which is provided in the wear body.

According to the present invention, there is provided an arm wear type communication device, in which the plurality of wear bodies are disposed in the positions facing the communication device body, and the communication device body is adapted to compare the reception states of signals which are respectively obtained from the plurality of antennas provided in the plurality of wear bodies, respectively.

According to the present invention, there is provided an arm wear type communication device, in which the wear body has a curved part having a curvature which is smaller than that of a part of the physical body when a part of the wear body is held to the part of the physical body, and the antenna is provided in the curved part.

According to the present invention, there is provided an arm wear type communication device, in which the antenna is formed in such a way that a pattern made of a conductor foil is formed on the surface of a material which is obtained by mixing a resin with a high dielectric material so as to become a chip shape.

According to the present invention, there is provided a high dielectric chip antenna which includes: a conductor foil which is provided on the surface of a chip-shaped material which is obtained by mixing a resin with a high dielectric material, and a pattern which is formed on the surface on the conductor foil.

The arm wear communication device is constituted by a communication device body, and wear bodies for wearing the communication device body to an arm. As for the wear body, there are an arm holder type band with which an arm is held by two pieces of arm holders, in addition to a belt type band with which an arm is held by a uniform material such as a belt, and a band with which multiple pieces are coupled in such a way as to make a loop around an arm. Antennas of the arm wear type communication device according to the present invention are not accommodated in the chassis constituting the communication device body, but are mainly accommodated in the wear bodies and are electrically connected to the communication device body through the coupling parts between these antennas and the wear bodies. Therefore, when the communication device is being worn to an arm, the transmission and reception of the electric wave are carried out on the radius side and the ulna side of an arm. When the communication device body is detached from an arm to be put to an ear in order to be used, there are carried out the transmission and reception of the electric wave in which the reduction of the antenna performance due to grasping the communication device body is avoided.

In general, while in the arm wear type communication device, the coating is applied to the facing of the body thereof and the wear bodies, this coating has the electric wave shielding function. Therefore, in the present invention, in order to avoid that function, the antennas are respectively accommodated in the wear bodies which do not have the coating applied thereto. However, in this case, it is also contained therein that only the parts each having the antenna accommodated therein suffer the masking in order to save the coating. In addition, the ceramics coating and the like are not contained in the coating. As for the kind of antenna, a chip antenna having a flat shape is adopted. Thus, the antenna of interest, even if the wear body is curved, can be readily accommodated in the wear body. In addition, as the chip antenna, there is adopted one which has the directivity on a single face. Here, as for the chip antenna, there are a high dielectric chip antenna and a metal chip antenna.

The fact that the communication device body is worn to an arm by the wear bodies is as stated above. Then, in the case where the wear body is the so-called belt type wear body, the chip antennas are disposed in the parts which are located on the both sides of the communication device body, i.e., the wear bodies of interest. In the case as well of the band type wear body which is formed by coupling multiple pieces to one another or the arm holder type wear body with which an arm is held by two pieces, the chip antennas are disposed in the positions similar thereto. That is, the two antennas are disposed in such a way as to hold the communication device body between them, and are electrically connected to the communication device body. In such a way, in the state in which the communication device body is worn to an arm as well as in the state in which the communication device body is held by one hand, the two antennas which are disposed apart from each other spatially are disposed in the positions where the degradation of the reception sensitivity due to the human body can be avoided.

In addition, by the high dielectric material is meant the material having a dielectric constant which is higher than that of air, and more specifically, is meant ceramics, a plastic resin, a metallic plate and the like. Here, ceramics contains therein the material which is obtained by mixing a resin with ceramics. As for the chip antenna utilizing such a high dielectric material, there is taken as an example one in which the antenna pattern is formed on the high dielectric material of interest using a conductor foil. Thus, there are a helical pattern, a reverse F pattern and the like.

In the present invention, the arm wear type communication device in which the wear body is not of a belt type, but is of an arm holder type having two pieces of arm holders is made the base. In general, the two pieces of arm holders are coupled to the communication device body of interest on the both sides of the communication device body, and hold pivotally an arm in the coupling part of interest. As a result, when the communication device body is worn to an arm, the two antennas which are respectively accommodated in the above-mentioned two pieces of arm holders are respectively located on the radius side and the ulna side of an arm. In addition, when the communication device body is held by one hand, the two pieces of arm holders which are taken off from an arm are located apart from a hand holding the communication device body. Since the antennas are accommodated in the respective arm holders, it is possible to avoid the influence of the reception degradation function due to the human body.

If it is assumed that the above-mentioned arm holders are worn/detached to/from an arm by the simple pivotal movement, then the degree of freedom of the positions which the arm holders of interest have with respect to the communication device body may be reduced. However, if it is taken into consideration that the antennas are accommodated in the respective arm holders, that fact means that the antenna positions with respect to the communication device body are further stabilized. The two antennas, similarly to the foregoing, are disposed in such a way as to hold the communication device body between them to be electrically coupled to the body, respectively. In such a way, in the state in which the communication device body is worn to an arm as well as in the state in which the communication device body is held by one hand, the two antennas which are disposed apart from each other spatially are disposed in the positions where the degradation of the reception sensitivity due to the human body can be avoided.

In general, the arm wear communication device is additionally provided with a speaker and a microphone. Then, when the body is held by one hand, the wear body on the speaker side is put to an arm to be used. In order to wear the communication device body to an arm, the wear body may adopt the various shapes and structures. For this reason, the two antennas may not be respectively disposed on the both sides of the communication device in some cases. In such cases, the one chip antenna is accommodated in the wear body on the speaker side. In such construction as well, when the communication device body is being worn to an arm as well as when the communication device body is being held by one hand, the grounding effect due to the human body is avoided and the transmission and reception having the suitable directivity become possible.

As described above, it is known that the antenna suffers the influence of the electric wave shielding function of the coating for the chassis in which the antenna is accommodated. In the present invention, the wear bodies in which the antennas are respectively accommodated are coated with ceramics such as an acrylic glass, whereby it is possible to prevent the electric wear shielding function as when carrying out the coating. In addition, the finishing of the wear body becomes smooth while preventing the above-mentioned function.

The antenna is electrically connected from the feeding point to the communication device. Thereby, the transmission and reception in the communication device becomes possible. The high dielectric chip antenna according to the present invention is constructed by applying the antenna pattern made of a conductor foil to the material having a high dielectric constant. As the typical antenna patterns, there are given the reverse F type, the helical type, λ/4 short-circuiting microstrip and the like.

High dielectric, in addition to dielectric itself, contains therein the material which is obtained by mixing a resin with ceramics. For such high dielectric, the die forming becomes possible. Thereby, the shape of the high dielectric chip antenna according to the present invention can be fitted to the various shapes which the wear body adapted to be fitted to the arm shape has. In addition, this high dielectric chip antenna can be accommodated in the wear body of interest. Such a high dielectric chip antenna can also be designed in such a way that the flat face of the wear body has the directivity depending on the installation direction. If the design is made in such a way that the single face has the directivity, then it is possible to maintain the directivity which is convenient for when the body is being worn to an arm as well as the body is being held by one hand.

### BRIEF DESCRIPTION OF THE SEVERAL VIEWS OF THE DRAWINGS

A preferred form of the present invention is illustrated in the accompanying drawings in which:

FIG. 1 is a conceptual view showing a structure of an arm wear -type communication device according to a first embodiment of the present invention;

FIG. 2 is an exterior view showing the actual use form of an arm wear type communication device;

FIG. 3 is a perspective view showing construction of an example of a chip antenna;

FIG. 4 is an exploded view showing the state in which a chip antenna is inserted into an arm holder; and

FIG. 5 is a conceptual view showing a structure of an arm wear type communication device according to a second embodiment.

### DETAILED DESCRIPTION OF THE PREFERRED EMBODIMENTS

The present invention will hereinafter be described in detail with reference to the accompanying drawings. However, it is to be understood that the present invention is not intended to be limited to the embodiments.

(Embodiment 1)

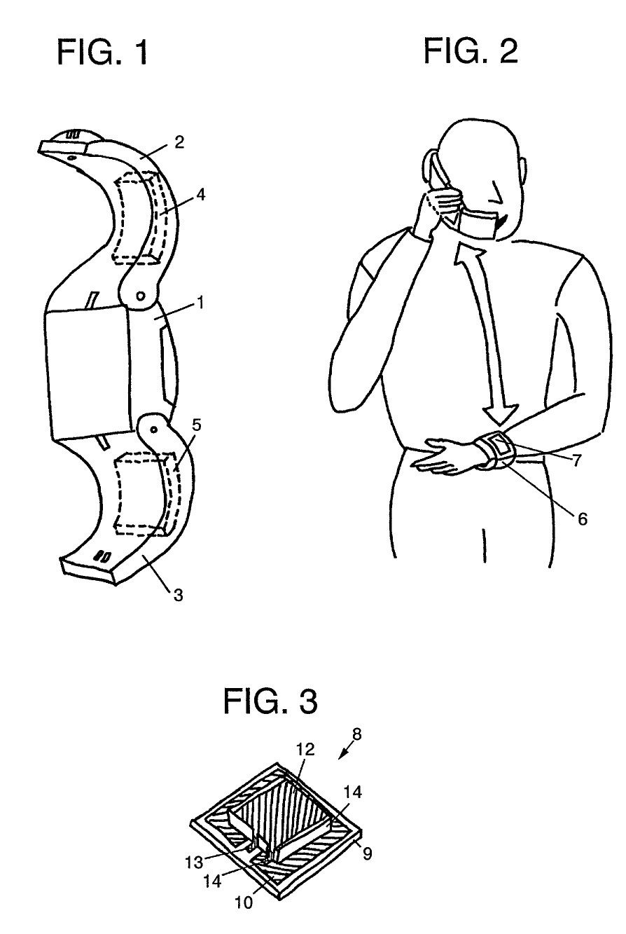

FIG. 1 is a conceptual view showing a structure of an arm wear type communication device according to a first embodiment of the present invention. A first arm holder 2 and a second arm holder 3 are provided as wear bodies in the both sides of a communication device body 1. These arm holders 2 and 3 are pivotably provided by the hinges which are respectively provided in the coupling parts between these arm holders 2 and 3 and the communication device body 1. In such a way, the wear body may be either of an arm holder type having two pieces of arm holders or of a type which is constructed by coupling one piece of arm holder or three pieces or more of arm holders to one another.

Chip antennas 4 and 5 each having a flat shape are respectively disposed in the insides of the above-mentioned arm holders 2 and 3. The communication device body 1 is electrically connected to the above-mentioned chip antennas 4 and 5 through the respective coupling parts, and is adapted to demodulate the electric wave which has been received through the chip antennas 4 and 5 and to modulate the voice for the transmission. In addition, the communication device body 1 is equipped with a console panel, a liquid crystal panel and the like (not shown) which are utilized by a communicator.

In addition, the coating is not applied to the arm holders 2 and 3, and the surfaces of the arm holders 2 and 3 are coated with ceramics such as an acrylic glass. The reason that no coating is applied to the arm holders 2 and 3 results from that the electric wave shielding function of the coating is avoided. Then, if the chip antennas 4 and 5 each having the excellent directivity are utilized, then only the parts in which the chip antennas 4 and 5 are accommodated may be subjected to the masking processing in order to save the coating.

FIG. 2 is an exterior view showing the actual use form of the arm wear type communication device. As shown in the figure, when the communication device body is being worn to an arm, the chip antennas 4 and 5 are located on the radius side 6 and the ulna side 7 of an arm to carry out the transmission and reception of the electric wave. In the case where the communication device body 1 is detached from an arm to be put to an ear in order to be used, the transmission and reception of the electric wave in which the grounding effect due to the human body is avoided are carried out.

FIG. 3 is a perspective view showing construction of an example of a chip antenna. Normally, a chip antenna 8 includes a grounding pattern 10 formed on an antenna substrate 9, a dielectric material 11 which is disposed on the upper part of the grounding pattern 10, and a conductor foil called a patch pattern 12 which is provided on the upper surface of the dielectric material 11. The chip antenna 8 shown in the figure is electrically connected to the communication device from a feeding point 13 provided on the side part of the dielectric material 11.

A short-circuiting part 14 for causing the patch pattern 12 and the grounding pattern 10 to conduct is provided in the vicinity of the feeding point 13 to form the so-called rectangle reverse F type chip antenna. As for the patch pattern, in addition thereto, the helical pattern or the like may be formed. In addition, the ë/4 short-circuiting microstrip type antenna may also be formed depending on the feeding point, the grounding point, the size of the rectangular patch pattern, and the like.

As for the dielectric material, the various kinds of materials may be utilized. That is, ceramics itself and the material which is obtained by mixing a resin such as plastic with ceramics may also be utilized. As a result, it is possible to form the high dielectric material having a high dielectric constant. In addition, for such a high dielectric material utilizing the resin, the die forming such as the injection molding becomes possible. As a result, the shape of the high dielectric chip antenna according to the first embodiment can be fitted to the various shapes, e.g., the curved shape and the flat shape, which the wear body adapted to be fitted to the arm shape has. For this reason, the high dielectric chip antenna can be accommodated in the wear body of interest without spoiling the fine sight.

In the high dielectric chip antenna as described above, the directivity can be provided in the direction perpendicular to the antenna pattern. By utilizing this fact, if the antenna surface having the directivity of interest is disposed on the curved convex side of the wear body, in the state in which the communication device is worn to an arm as well as in the state in which the communication device is held by one hand, the excellent communication in which the influence of the human body is avoided becomes possible.

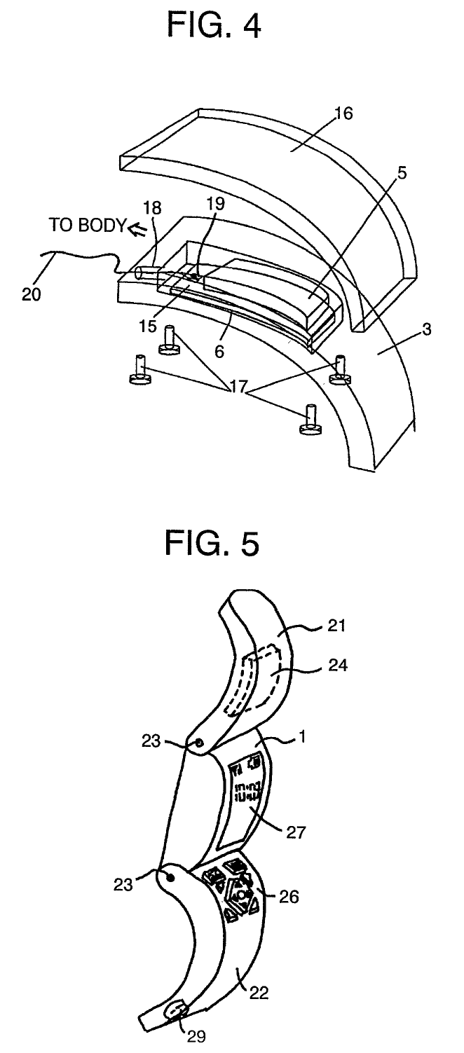

FIG. 4 is an exploded view showing an example of the state in which the chip antenna is inserted into the arm holder. In this case, there is shown an example in which the chip antenna 5 is inserted into the arm holder 3 on the radius side of the two pieces of arm holders 2 and 3. The arm holder 3 has in the body the space in which the chip antenna 5 and an antenna substrate 15 are accommodated, and is covered with an arm holder cover 16 using screws 17. In addition, the arm holder 3 is coupled to the communication device body 1. Then, an antenna coaxial cable 20 through which a chip antenna feeding point 19 is electrically connected to the communication device body 1 is introduced into a communication hole 18 which is provided in the coupling part of the arm holder 3 directed to the communication device body 1. As a result, the chip antenna5 achieves its function without appearing in the exterior appearance. However, while in this case, the simplest insertion example is shown, the insertion construction is not intended to be limited thereto. That is, the arm holder 3 and the arm holder cover 16 may be made slidable or engageable.

In addition, when the communication device body is being worn to an arm, the two antennas which are respectively accommodated in the two pieces of arm holders are located on the radius side and the ulna side of an arm, respectively. In addition, when the communication device body is being held by one hand, the two pieces of arm holders in the state in which they are taken off from an arm are located apart from a hand holding the communication device body. The arm wear type communication device is basically the mobile communication device. The mobile telecommunication, unlike the fixed station telecommunication, is easy to suffer extremely the multiple fading due to the electric wave reflected by the obstructions such as buildings, or the diffracted electric wave. As described above, the fact that the two antennas are located apart from each other spatially is advantageous in terms of avoiding the influence of such multiple fading.

As described above, according to the arm wear type communication device of the first embodiment of the present invention, when the communication device body is detached from an arm to be held by one hand as well as when the communication device body is being worn to an arm, the influence of the human body is avoided so that the excellent telecommunication becomes possible. In addition, this arm wear type communication device is free from the electric wave shielding effect due to the coating. Also, by paying attention to the disposition of the antennas each having the directivity which is optimal for when the communication device is being worn to an arm and when the communication device body is being held by one hand, the chip antennas each of which has the flat shape and has the single directivity are accommodated in the wear bodies, respectively. As a result, the antenna transmission and reception adapted to the actual use form of the communication device become possible. If the wear body is of the arm holder type, then the shift from the state in which the communication device body is being worn to an arm to the state in which the body is being held by one hand can be quickly readily carried out and also it is possible to hold the antennas in the optimal positions. Furthermore, if the chip antennas are respectively accommodated in the wear bodies which are respectively disposed on the both sides of the communication device body, then the diversity reception also becomes possible by using the two chip antennas which are disposed apart from each other spatially. In this case, both of the chip antennas may have the same characteristics or may have the performance in which the characteristics in the polarization direction are different.

(Embodiment 2)

FIG. 5 is a conceptual view showing an arm wear type communication device according to a second embodiment of the present invention. In the figure, a point that a first arm holder 21 and a second arm holder 22 are provided as the wear bodies on the both sides of the communication device body 1, respectively, is the same as that of the first embodiment. In addition, a point that these arm holders 21 and 22 are pivotably provided through hinges 23 which are respectively provided in the coupling parts between these arm holders 21 and 22, and the communication device body 1 is also the same as that of the first embodiment. Here, the wear body may be of the arm holder type having two pieces, or may be constructed by one piece or three pieces or more of coupling members.

A chip antenna 24 having a flat shape is disposed in the arm holder 21 which is located on the speaker side, when being worn to an arm, of the above-mentioned two pieces of arm holders 21 and 22. The communication device body 1 is electrically connected to the above-mentioned chip antenna 24 through the coupling part and is adapted to demodulate the electric wave which has been received through the chip antenna 24 and to modulate the voice for the transmission. In addition, the communication device body 1 is equipped with manipulation buttons 26 and a liquid crystal panel 27 which a communicator utilizes. The arm holders 21 and 22 are equipped with a speaker 28 and a microphone 29, respectively.

In addition, a point that the surfaces of the arm holders 21 and 22 have no coating, but are coated with ceramics such as an acrylic glass is the same as that of the first embodiment. As described in the first embodiment, the wrist bone is constituted by the two bones, i.e., the radius on the side of the thumb and the ulna on the side of the little finger. The arm holders 21 and 22 according to the second embodiment of the present invention are worn in such a way as to envelop both of the radius and the ulna of an arm.

The arm holders 21 and 22 may adopt the various shapes and structures in order to wear the communication device body 1 to an arm. In the case where the antenna chips can not be respectively disposed in the arm holders 21 and 22 on the both sides of the communication device body 1 due to such shapes, structures and the like, one chip antenna is accommodated in the arm holder 21 on the speaker side. Even when such construction is adopted, the transmission and reception can be carried out with the excellent efficiency when the communication device body 1 is being worn to an arm and when the communication device body 1 is being held by one hand.

Therefore, according to the arm wear type communication device of the second embodiment of the present invention, the transmission and reception can be efficiently carried out with the influence of the human body avoided when the communication device body is being worn to an arm and when the communication device body is being held by one hand.

As described above, according to the arm wear type communication device of the present invention, the excellent communication becomes possible with the influence of the human body avoided when the arm wear type communication device is detached from an arm to hold the communication device body by one hand as well as when the arm wear type communication device is being worn to an arm. In addition, this arm wear type communication device does not suffer the electric wave shielding effect due to the coating at all. Also, by paying attention to the antenna disposition having the optimal directivity for when the arm wear type communication device is being worn to an arm and when the communication device body is being held by one hand, the chip antennas each of which has the flat shape and has the single directivity are accommodated in the wear bodies, respectively. As a result, the antenna transmission and reception adapted to the actual use form of the communication device can be carried out.

In addition, according to the arm wear type communication device of the present invention, when the communication device is being worn to an arm and when the communication device is being held by one hand, the degradation of the reception sensitivity due to the human body can be avoided so that the suitable transmission and reception become possible. In addition, the diversity transmission and reception become possible using the two antennas which are disposed apart from each other spatially. Also, if utilizing the high dielectric chip antenna, the small and high performance antenna can be accommodated in the wear body which may be formed into the various shapes.

In addition, according to the arm wear type communication device of the present invention, it is possible to obtain the property of the arm holder type wear body in which the shift from the state in which the body is being worn to an arm to the state in which the body is being held by one hand can be quickly carried out, and also it is possible to hold the stable antenna position. If the antennas are respectively accommodated in the two pieces of wear bodies which are respectively disposed on the both sides of the communication device body, in the state in which the communication device body is held by one hand as well as in the state in which the communication device body is worn to an arm, it is possible to avoid the degradation of the reception sensitivity due to the human body. In addition, similarly to the foregoing, the diversity reception becomes possible using the two antennas which are disposed apart from each other spatially.

In addition, according to the arm wear type communication device of the present invention, when the communication device body is being held by one hand as well as when the communication device body is being worn to an arm, the influence of the human body can be avoided so that the efficient transmission and reception can be carried out.

In addition, according to the arm wear type communication device of the present invention, when the communication device body is being held by one hand as well as when the communication device body is being worn to an arm, the electric wave shielding function due to the coating can be avoided and also the efficient transmission and reception can be carried out with the influence of the human body avoided.

Also, according to the high dielectric chip antenna of the present invention, the shape of the high dielectric chip antenna can be fitted to the various shapes each of which the wear body adapted to be fitted to the arm shape has. Moreover, this high dielectric chip antenna can be accommodated in the thin wear body. If the antenna pattern is suitably selected, then the miniaturization of the antenna becomes possible. Thus, even if the chip antennas are accommodated in a plurality of places of the wear bodies, this is not a hindrance to the manipulation of the communication device. Even when the antennas are accommodated in a plurality of places of the wear bodies, if these antennas are controlled, then the diversity reception which suffers the less influence of the fading commonly associated with the mobile telecommunication becomes possible. Such a high dielectric chip antenna can cause the flat surface of the wear body to have the directivity depending on the installation direction. If the single surface is caused to have the directivity, then it is possible to maintain the directivity which is convenient for when the arm wear type communication device is being worn to an arm and when the communication device body is being held by one hand.

What is claimed is:

1. An arm wear type communication device, comprising:
a communication device body for transmitting and receiving a signal;
a wear body which is pivotally fixed to the communication device body in order to be worn to an arm;
a sound unit which is provided in the wear body; and
an antenna which is located between the sound unit and the communication device body and which is provided in the wear body.

2. An arm wear type communication device according to claim 1, wherein the plurality of the wear bodies are disposed in the positions facing the communication device body, and the communication device body is adapted to compare the reception states of signals which are respectively obtained from the plurality of the antennas provided in the plurality of the wear bodies, respectively.

3. An arm wear type communication device according to claim 1, wherein the wear body has a curved part having a curvature which is smaller than a curvature of a part of the physical body when a part of the wear body is held to the part of the physical body, and the antenna is provided in the curved part.

4. An arm wear type communication device according to claim 2, wherein the wear body has a curved part having a curvature which is smaller than a curvature of a part of the physical body when a part of the wear body is held to the part of the physical body, and the antenna is provided in the curved part.

5. An arm wear type communication device according to claim 1, wherein the antenna is formed in such a way that a pattern made of a conductor foil is formed on the surface of a material which is obtained by mixing a resin with a high dielectric material so as to become a chip shape.

6. An arm wear type communication device according to claim 2, wherein the antenna is formed in such a way that a pattern made of a conductor foil is formed on the surface of a material which is obtained by mixing a resin with a high dielectric material so as to become a chip shape.

7. An arm wear type communication device according to claim 3, wherein the antenna is formed in such a way that a pattern made of a conductor foil is formed on the surface of a material which is obtained by mixing a resin with a high dielectric material so as to become a chip shape.

8. A high dielectric chip antenna, comprising:
a conductor foil which is provided on the surface of a chip-shaped material which is obtained by mixing a resin with a high dielectric material; and
a pattern which is formed on the surface on the conductor foil.
